(19) United States
(12) Patent Application Publication
(10) Pub. No.: US 2003/0223401 A1
(43) Pub. Date: Dec. 4, 2003

(54) Mehtod of data packet transmission and associated transmitter and receiver

(75) Inventors: Wolfram Lautenschlager, Sachsenheim (DE); Stefan Schabel, Niederstotzingen (DE); Stephan Bunse, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/438,811

(22) Filed: May 16, 2003

(30) Foreign Application Priority Data
May 31, 2002 (EP) 02360160.2

(51) Int. Cl. H04L 12/28

(52) U.S. Cl. 370/351

(57) ABSTRACT

A method for the asynchronous transmission of data packets in telecommunication networks with a bit rate B is characterized by methoding of the data to be transmitted such that the probability of the occurrence of a 0 or 1 state in the data stream at each bit position is approximately equal and independent of other bit positions (=scrambling); waiting for a guard band time t_{gb}, transmission of a synchronization sequence during time t_{sy}, transmission of a synchronization word during time t_{co}, and transmission of the data payload; detection of a synchronization sequence and synchronization to this in a receiver; detection of the start of the data packet by detection of the synchronization word in the receiver; reception of the data payload in the receiver.

### BACKGROUND OF THE INVENTION

The invention is based on a priority application EP 02360160.2 which is hereby incorporated by reference.

The invention relates to a method for the asynchronous transmission of data packets in telecommunication networks with a bit rate B, and transmitters and receivers for performance of the method.

The invention further relates to a method for the synchronous transmission of data packets in telecommunication networks, where the data payload to be transmitted is embedded in a frame structure according to standard G.709.

Such a method for asynchronous transmission of data packets and a corresponding receiver unit are known from a publication by H. Nishizawa et al., 26th European Conference on Optical Communication, ECOC 2000, Sep. 3-7, 2000 Munich, Germany, Paper 10.4.8, vol 4, pages 75 ff.

Data transmission with a high information flow i.e. a high number of binary information units (bits) to be transmitted per time unit, in particular at 9.95328 GBit/s (10 GBit/s) and more, takes place in optical information networks primarily by point-to-point connections. Here in the simplest case signals are passed continuously from a transmitter unit of a first network point via a light waveguide exclusively to a receiver in a second network point. Even if occasionally no data needs to be transmitted between the two network points, a signal flow is maintained. As a result the receiver can maintain its read phase and read bit position (i.e. synchronization with the transmitter unit) and the limit level (i.e. the threshold intensity below which signal is perceived as “0” and above which the signal is perceived as “1”). This method of data transmission is therefore known as “synchronous”.

At the receiver the data are unpacked and read in order to determine the destination of the data packet. The information is then repacked into a data packet which is then passed by the transmitter unit of the second network point to a third network point, where this third network point is closer to the destination of the data packet than the second network point.

An alternative to this is data transmission in burst mode; this is known as “asynchronous” data transmission. It is suitable in particular for IP data traffic (internet) in which short data packets must be exchanged between constantly changing transmitter and receiver pairs. Lines from various other network points merge at one network point (between transmitter and receiver). An incoming data packet on one of the lines is passed via an optical switch directly physically (i.e. without reading) to another line of the network point. This line is selected according to the destination of the data packet, where this destination information is taken from a short header data packet. The header is the only part read; its transmission can be time-delayed or take place on a separate channel.

At such a network point the times of data packet input and transfer alternate with periods of darkness (i.e. no input of signals). In times of darkness where applicable a switching of the output line takes place for the next data packet to be transferred.

The receiver of a burst mode network has two difficulties to overcome: firstly not only the frequency (bit rate) but also the phase of an incoming signal is not known. The receiver must therefore be synchronized to each incoming signal packet. Secondly the amplitudes of the incoming signal packets vary from transmitter to transmitter, for example because of attenuation effects in different lengths of signal line running to the network point. Therefore the limit level for each incoming data packet must be recalibrated. The faster switching can take place between two different transmitters, the higher the possible data throughput.

Consequently to receive burst mode signals, special receivers are required. Such a burst mode receiver is described by Nishizawa et al., idem. At the receiver are present both a Manchester-coded optical data packet and an extraction signal. The optical data packet is amplified with an EDFA preamplifier and supplied to a differential photodetector. Its signal is linear-amplified, high-pass-filtered and supplied to an electrical limiting amplifier. The data packet and extraction signal are finally analysed with a digital ring oscillator and a decider circuit so that the original data packet is present at the receiver output as an electrical non-return to zero (NRZ) signal. The optical data packets used consist of short prefix bits for synchronisation and the data payload. The extraction signal supplied to the receiver in parallel to the optical signal indicates the prefix period.

Such a burst mode receiver in comparison with signal receivers for continuous (synchronous) signal transmission is complex and expensive in structure. Problems occur with detecting the start of the data payload, for which an additional control signal, the extraction signal, is required.

### SUMMARY OF THE INVENTION

The object of the invention is to construct the burst mode method such that a signal receiver can easily and directly detect the data payload of a data packet, and also the signal receiver can be constructed largely on the basis of known hardware technology from receivers of continuous point-to-point connections.

### ADVANTAGES OF THE INVENTION

This is achieved in a method according to the invention in that the asynchronous transmission of data packets in telecommunication networks with a bit rate B which includes the following steps:

(a) methoding of the data to be transmitted such that the probability of the occurrence of a 0 or 1 state in the data stream at each bit position is approximately equal and independent of other bit positions (scrambling);

(b) waiting for a guard band time t_{gb}, transmission of a synchronisation sequence during time t_{sy}, transmission of a synchronisation word during time t_{co}, and transmission of the data payload;

(c) detection of a synchronisation sequence and synchronisation to this in a receiver;

(d) detection of the start of the data packet by detection of the synchronisation word in the receiver;

(e) reception of the data payload in the receiver.

To receive data packets structured according to the invention, a receiver originally designed for continuous signal reception can be adapted according to the invention by raising the lower limit frequency fᵤ of the receiver. This avoids a memory effect of the receiver beyond the packet limits. However as a result signal sequences with a high DC part (i.e. sequences with many zeroes or many ones in direct succession) are only received disrupted. For this reason according to the invention a scrambling method of data encryption is applied to avoid such sequences.

For this reason according to the invention at least one scrambling method is applied which irrespective of the nature of the data payload guarantees the even and independent distribution of the bits (in the example of a fax, almost all “bits” are “white” and only a few are “black”; only by scrambling is an evenly distributed 0/1 sequence achieved). Channel coding is better than scrambling. Here additional bits are inserted in the data stream so that undesirable bit sequences can generally be excluded (scrambling cannot exclude such undesirable sequences, merely makes them extremely improbable according to length). Manchester coding is an extreme example of channel coding in which for each bit to be transmitted, an extra bit is transmitted. This guarantees a bit change in the signal at the latest in the third successive signal bit. However the data throughput is also halved.

An alternative coding provides for example that a sequence of 8 information bits (or a comparable order of magnitude) is transmitted in a 10-bit signal, where bit 9 and bit 10 differ, i.e. are approximately 0 and 1. As a result a bit change in the signal is guaranteed at the latest after 10 bits. This coding reduces the data throughput by just 20%.

By scrambling or coding, the DC proportion of the signal is reduced so far that cutting out the lower-frequency signal parts below the lower limit frequency causes no information loss, i.e. in the coded signal there are no lower-frequency sections.

In order at a lower limit frequency fᵤ of B/300 to achieve the same bit error rate (typically 10⁻¹²) as at a non-raised lower limit, a signal-to-noise ratio better then 3 dB is required. This con be achieved by raising the transmission power. Higher lower limit frequencies lead to a strong rise in bit error rate irrespective of the signal-noise ratio and hence to a greater probability of packet loss.

During the synchronisation sequence t_{sy}the receiver has the opportunity to tune into the data packet. This is utilised in particular to determine the phase of the incoming signal and synchronise the receiver to this, and to determine the intensity of the incoming signal in order to establish the limit level. A simple synchronisation sequence consists of sequence 101010 . . . etc.

The decision threshold (limit level) is set during the synchronisation sequence to the mean signal value. The first bits may under some circumstances not be detected and be lost, as during this period certain recognition of 0 and 1 is not possible. The minimum tuning time t_{sy} arises from the tuning time for the high-pass of the receiver over fᵤ according to t_{Sy≧}1/(2*π*fᵤ), where fᵤ=B/300 and t_{sy}≧53/B. In this case the synchronisation sequence must be at least 53 bits long; in practice 100 bits is selected which at B=10 GBit/s corresponds to a t_{sy} of 10 ns.

By including a synchronisation word, the start of the data payload is defined. This is necessary as an undetermined number of bits at the packet start are lost during synchronisation. The synchronisation word should have a narrow auto-correlation function and the greatest possible code interval for both the synchronisation sequence (e.g. 101010 . . . ) and for the signal pause (0000 . . . ). A 16-bit synchronisation word is not generally sufficient. The inclusion of the synchronisation word makes the control signal (extrusion signal) to identify the start of the data payload superfluous and no time-critical switch methodes need take place.

The guard band time t_{gb} is necessary to give the receiver, after reception of a packet with maximum transmission power, time to detune so that then a packet with the minimum permitted transmission power can still be detected reliably. At a lower limit frequency fᵤ=B/300 and power fluctuation of 7 dB, the guard band t_{gb} corresponding to 150 Bit is given, i.e. at B=10 GBit/s approx. 15 ns.

The receiver specifies a minimum guard band which must be observed by the synchronicity of the higher system consisting of several transmitters and optical switches.

This higher system is a mesh structure of network points which in the case of an optical burst mode network consists of the multiplicity of light waveguides, where applicable with amplifier elements, and optical switches. At least one line leads from one of the optical switches to the receiver. Star, ring and tree-like structures are possible.

The size of the data payload proportion in the data packet is in principle not restricted with the method according to the invention or the receiver according to the invention. Both fixed packet lengths and variable packet lengths are possible. The size of the data payload proportion however does influence the channel utilisation i.e. the proportion of the data payload transport in the entire signal traffic. The longer the data payload section of the data packet, the better (higher) the channel utilisation. In a 10 GBit/s data network with an average pause of 50 ns between two packets and a synchronisation sequence of 12 ns and a data payload length of 1 μs (10000 bits), the channel utilisation is approximately 95%.

In a particularly preferred variant of the method according to the invention, the data packets are transmitted by a high bit-rate, optical data transmission with B≧9.95328 Gigabit/second. The standard of 9.95328 GBit/s is described in brief as 10 Gbit/s. At such high bit rates, the advantages of the invention are particularly clear. Optical systems are able to achieve such high bit rates.

A variant of the method according to the invention in which the data packets are transferred in burst mode is particularly preferred. This is the conventional method of asynchronous signal transmission in which the invention is particularly applicable.

A method variant according to the invention provides that to method the data in step (a) a coding method is used in which the power spectrum of the coded data does not have any intensity at frequencies below 0.01*B, in particular no intensity below 0.003*B. In the case of B≈10 Gbit/s these frequencies correspond to 100 MHz and 30 MHz. This minimises information loss in the receivers on data transmission as the data signal is applied via a high-pass at the receiver according to the invention.

The method according to the invention in a preferred variant provides that the data packets are transmitted by several transmitters on a network element which passes the data packets in time multiplex on a common output line to a selected receiver. Further network elements can be connected to the network element as transmitters. Only when the network element is linked with several transmitters is burst mode operation fully applicable. This achieves a good data throughput.

In the structure of the two previous method variants of the method according to the invention for asynchronous data transmission, the network element causes a temporal separation of at least t_{gb} between an end of a first data packet and the start of a second transmitted data packet. This prevents collision of data packets at the receiver and the receiver is sufficiently relaxed (detuned) before a new data packet reaches it.

A particularly preferred variant of the method according to the invention provides that the guard band is selected as t_{gb}≧100/B. This guard band is sufficient for the receiver, after receiving a data packet with high signal intensity, to return to its starting condition i.e. detune, so that after t_{gb} a signal with low intensity is reliably detected. The size of t_{gb} according to the invention thus improves the reliability of data transfer.

In a preferred method variant the lower limit frequency of the receiver input lies between 0.0005*B and 0.005*B, preferably between 0.001*B and 0.003*B. At B≈10 GBit/s this corresponds to frequencies of 5 MHz, 50 MHz, 10 MHz and 30 MHz. Due to the lower limit frequency of the receiver input set according to the invention, a conventional receiver intended for continuous signal reception can be used for the reception of packets. The values here constitute an optimum range of data security and data throughput.

The scope of the present invention also includes a transmitter for transmission of data packets in the above method according to the invention and its variants, where means are provided for the performance of steps (a) and (b). Thus data packets according to the invention can be generated on a signal line.

The invention further includes a receiver for the transmission of data packets in the above method according to the invention and its variants, where means are provided for performance of steps (c), (d) and (e). Thus data packets according to the invention can be read from the signal line.

An embodiment of this receiver provides that a coupling capacitor is provided as a high-pass to raise the lower limit frequency of the receiver input. This shortens the detuning time of the receiver and recreates the readiness to record a new data packet quickly after the end of the previous data packet.

The invention also includes a method for synchronous transmission of data packets in telecommunication networks, where the data payload to be transmitted is embedded in a frame structure according to standard G.709, wherein

(i) in the ODUk overhead is inserted a connection code in coded form which allocates the data packet concerned to a particular network connection,

(ii) and that within a switching point the FEC part of the frame structure of the data packet is modified so that between the end of the previous data packet and the start of the immediately following data packet is a guard band time t_{gb}>20 ns and that an internal control signal to synchronize subsequent receiver units is generated within the switching center on the data packet.

Further advantages of the invention arise from the description and drawings. Also the features according to the invention stated above and further features to be listed can be applied individually or together in any combination. The embodiments shown and described should not be interpreted as a complete list but rather serve as examples to explain the invention.

### BRIEF DESCRIPTION OF THE DRAWINGS

The invention is shown in the drawing and explained in more detail with reference to embodiment examples. Here:

FIG. 1a: shows the frame structure of a data packet according to standard G.709;

FIG. 1b: shows the transmission sequence of a data packet to standard G.709;

FIG. 2: shows the diagrammatic structure of a connection point according to the invention for the transmission of data according to standard G.709 modified according to the invention;

FIG. 3: shows the internal data format of standard G.709 modified according to the invention.

### DETAILED DESCRIPTION

The asynchronous transmission of data packets (packet transmission) according to the invention causes a loss of channel capacity due to times t_{gb} (guard band) and t_{sy} (synchronisation sequence). (The synchronisation word is ignored in this assessment as it is negligibly short compared with t_{gb} and t_{sy}). The channel utilisation is therefore:

E=t_{pay}/(t_{gb}+t_{sy}+t_{pay}) (1)

(t_{pay}=period of net data payload).

A statistically independent and evenly distributed bit sequence (similar to scrambling) has a lower limit frequency fᵤ of 0 Hz. This is impractical for technical systems. The lower limit frequency can be raised to 1/300th of the bit rate provided a loss of 3 dB in the signal-to-noise ratio is accepted, which has been proven by simulation calculations.

fᵤ≦(1/300)*1/T (2)

(T=length of one bit, bit rate B=1/T, at B=10 GBit/s T=100 ps).

The tuning at the packet start must take place within t_{sy}. The minimum tuning time of the simple high-pass at the receiver input is approximately equal to time constant Tau which arises from the lower limit frequency.

t_{sy}≧Tau≅1/(2πfᵤ) (3)

or with (2)

t_{sy}≧53 T (4)

Thus the synchronisation sequence must be at least 53 bits long; in practice t_{sy} is extended to 100 bit (or 10 ns).

In optical packet transmission level jumps (intensity jumps) between the packets must be expected as the packets come from different sources. After a large i.e. powerful packet with power Pₘₐₓ, the receiver requires time t_{gb} to detune to a lower level of a possible smallest packet with power Pₘᵢₙ.

Pₘᵢₙ/Pₘₐₓ≅exp(−t_{gb}/Tau) (5)

As a result and taking into account (3)

t_{gb}≅53 Tln(Pₘₐₓ/Pₘᵢₙ) (6)

The power ratio in dB: (10 times decimal logarithm)

R=10 lg(Pₘₐₓ/Pₘᵢₙ₎ (7)

R=10 ln(Pₘₐₓ/Pₘᵢₙ₎/In 10

From (6) and (7) we get:

t_{gb}≅12.3 T*R (8)

This formula means:

with the same packet power (R=0) no guard band is required (t_{gb}=0).

with an assumed power fluctuation R≦7 dB we get

t_{gb}≧87 T (9)

As estimate R≦7 dB is arbitrary, a reserve is established, e.g. t_{gb}≧100 T, or better a clearer reserve with t_{gb}≧200 T, or t_{gb}≧20 ns.

In order to achieve the theoretical limit values t_{gb} and t_{sy}, to reach a minimum channel utilisation E, from (1) we conclude

E=t_{pay}/(12.3 T R+53 T+t_{pay}) (10)

where the time of payload t_{pay} arises from the number of data payload bits N times bit duration T: t_{pay}=N*T. Inserted in (10) and converted to N we get:

N≧(12.3 R+53)E/(1−E) (11)

With a required utilisation of at least 95% (E=0.95) N≧2700 bit. The data payload per packet must therefore be longer than 2700 bit, otherwise 95% utilisation cannot be achieved. Taking into account technical supplements on t_{gb} and t_{sy} to 200 T or 100 T (see above), the minimum length is N≧5700 bit.

In the method according to the invention it is assumed that the data was originally present as NRZ signals.

The method according to the invention for synchronous transmission of data packets in telecommunication networks will now be explained below, where the data payload to be transmitted is embedded in a frame structure according to standard G.709.

In WDM systems (WDM: wavelength multiplexer technology) switching methodes in network nodes are performed on the basis of the WDM channels. This however has the disadvantage that the granularity of these channels depends on the bit rate used, which can be up to 40 GBit/s. Thus it is difficult to construct close-mesh data transport networks as some connections will be utilised to an extremely low extent.

A solution in the state of the art is “burst switching”, see Nishizawa et al, idem., for which however a totally new protocol must be created which involves numerous format changes.

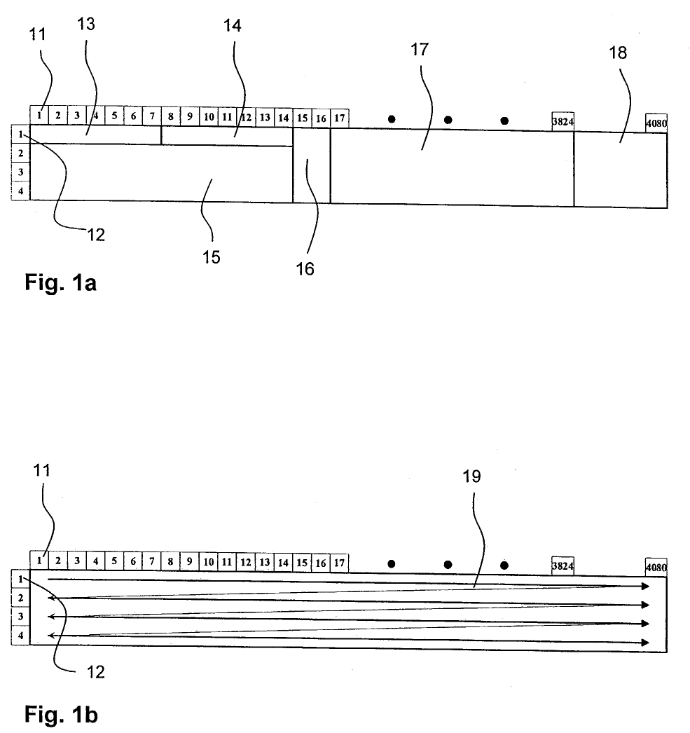

The better solution to this problem according to the invention is the introduction of “virtual wavelengths” in standard G.709 (on standard G.709, see FIG. 1a, 1b bottom and ITU-T G.709, February 2001). Bits defined at present as reserve or experimental in data frame structure G.709 can be used to distinguish different virtual wavelengths. The transport functions must then observe these virtual wavelengths, for example the monitor functions are performed individually for each virtual wavelength. The virtual wavelengths can be both of constant and variable bandwidth.

By the definition or structure of transport signals according to the invention it is possible to add easily a switching function to an optimum connection element (=a network node) which allows switching on the basis of virtual wavelengths.

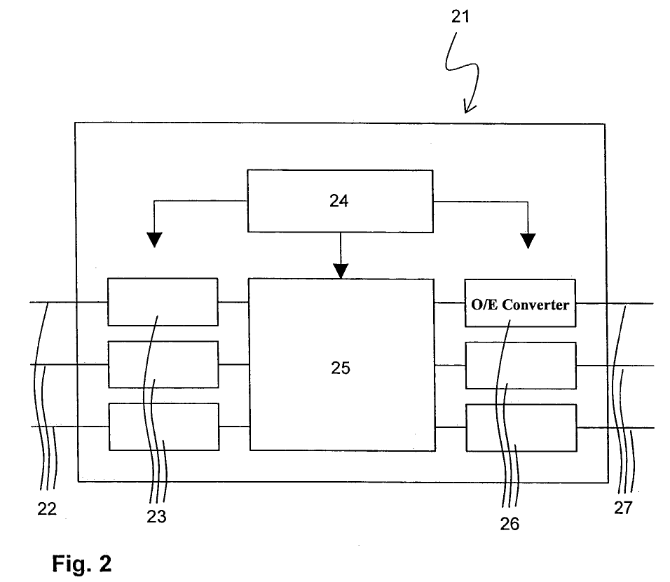

A switch device according to the invention is shown in FIG. 2 (see below). The line cards on the transmitter side fulfil the following functions:

FEC control calculations where available (FEC: forward error correction);

Adaptation of external data format (to standard G.709, “external frame structure”) to the internal data format (modified standard G.709 according to the invention, “internal frame structure”), in detail:

Rejection of the FEC field. This is superfluous as no transmission errors are possible within the switch.

Addition of a “burst overhead” and guard band for safe switching and reception of data signals.

The burst overhead contains at least one synchronization sequence, typically a sequence of 010101 . . . bits.

Standard G.709 and hence also the internal frame structure can be switched as a whole or in four part sections as the FEC field is also switched in four part sections, each of which is 256 Bytes long. This second possibility offers increased flexibility. As well as the phase (bit) synchronization sequence however, in this case a bit position (slot) synchronization sequence must also be added to the data signal as the corresponding synchronization sequence of G.709 frame structure (frame alignment overhead) is not available: this is only available in the first data row.

The reading of a table to establish to which output the virtual wavelength should be switched and whether the virtual wavelength should be changed;

Sending a request signal to a scheduler which controls the status of the switch matrix. The switch matrix passes the signals from one of its inputs to one of its outputs;

Storage of the internal frame structure i.e. the data packet until the scheduler releases the internal frame structure.

On the receiver side the line cards fulfil the following functions:

Reception of internal frame structures (data packets) in burst mode;

Removal of the internal data overhead;

Recalculation of FEC field if necessary, and

Transmission of data signal (i.e. the recreated outer frame structure) to the outer connection i.e. finally to the next network node or definitive recipient.

The task of the switch matrix is to switch the internal data structures precisely during the guard band times to avoid any type of data distortion. The internal use of the FEC field as an overhead has the advantage that no increase in transmission speed (speed up) is required, i.e. no different time systems need be noted.

In the connecting point the internal frame structure can be switched in burst mode i.e. a precise phase synchronization of all line cards is not required.

The synchronous method of signal transmission according to the invention allows the use of burst-mode-specific benefits without the entire network having to operate in burst mode but just part of the network node. The close correlation of the internal data format to the standard format G.709 is also advantageous.

FIG. 1a shows a frame structure according to the original G.709 standard. The view shows the numbered columns 11 and rows 12 of Bytes of the G.709 data packet. The first row begins with a synchronization sequence of frame structure 13 (frame alignment overhead), followed by the optical transport unit overhead (OTUk overhead) 14. In rows 2 to 4 these two areas 13, 14 are replaced by the optical data unit overhead (ODUk overhead) 15. In all four rows this is followed by the optical payload unit overhead (OPUk overhead) 16 followed by the data payload (OPUk payload) 17. All rows then conclude with a section of the forward error correction (FEC) 18.

The transmission sequence of data of such a frame structure is shown diagrammatically in FIG. 1b. Transmission is in rows starting with the first row in the first column and then following the row sequence of the column entries. On completion of the first row, transmission of the second row, starting with its first column, continues in the direction of arrow 19 until the entire frame structure has been methoded.

FIG. 2 shows a network node 21 which works with the method according to the invention for synchronous data transmission. Several inputs 22 lead to the set of line cards 23 on the transmitter side. On arrival of a data packet to standard G.709 at one of the line cards 23, the line card concerned passes a message to scheduler 24 and methodes the external frame structure into the internal frame structure according to the invention. Avoiding collisions and maintaining the minimum guard band of 20 ns, the scheduler now releases the internal frame structure to the matrix which was set by the scheduler according to the destination of the data packet, so that the internal frame structure is passed on to the corresponding line card of the set of line cards 26 on the receiver side. The original data format is recreated there and passed to the corresponding output line of output 27 of network node 21.

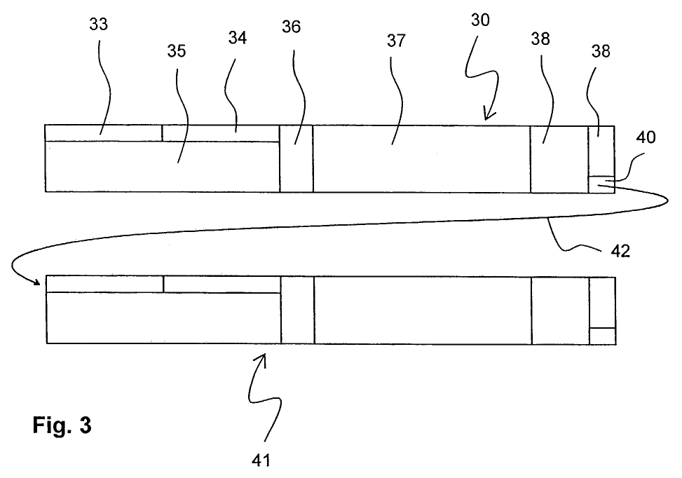

FIG. 3 shows the internal frame structure 30 and 41 as generated by the transmission-side line card from the incoming data packet of format G.709. Frame alignment overhead 33, OTUk overhead 34, ODUk overhead 35, OPUk overhead 36 and ODUk payload 37 are arranged as in standard G.709, see FIG. 1a. Instead of FEC 18 there is a guard band 38 and an internal overhead 39, where the guard band 38 extends over all rows, the internal overhead 39 however only over the first three rows. The internal overhead 39, also known as a “burst overhead”, thus indicates a subsequent data section of the type of a second to fourth row and can be used for synchronization, whereas omission of the internal overhead 39 corresponds with the start of a new internal frame structure. The final section 40 in FIG. 3 of the upper internal frame structure 30 is then already allocated to the lower internal frame structure 41 at which transmission continues according to arrow direction 42. The lower internal frame structure 41 is similar in structure to the upper internal frame structure 30.

1. Method for the asynchronous transmission of data packets in telecommunication networks with a bit rate B, including the following steps:
(a) methoding of the data to be transmitted such that the probability of the occurrence of a 0 or 1 state in the data stream at each bit position is approximately equal and independent of other bit positions (=scrambling);
(b) waiting for a guard band time t_{gb}, transmission of a synchronization sequence during time t_{sy}, transmission of a synchronization word during time t_{co}, and transmission of the data payload;
(c) detection of a synchronization sequence and synchronization to this in a receiver;
(d) detection of the start of the data packet by detection of the synchronization word in the receiver;
(e) reception of the data payload in the receiver.

2. Method according to claim 1, characterized in that the data packets are transmitted by a high bit rate optical data transmission at B≧9.95328 Gigabit/second.

3. Method according to claim 1, characterized in that the data packets are transmitted in burst mode.

4. Method according to claim 1, characterized in that to method the data in step (a) a coding method is used in which the power spectrum of the coded data has no intensity at frequencies below 0.01*B, in particular no intensity below 0.003*B.

5. Method according to claim 1, characterized in that the data packets are sent by several transmitters on a network element which passes the data packets on a common output line to a selected receiver.

6. Method according to claim 5, characterized in that the data packets are transmitted in the network element in time multiplex.

7. Method according to claim 5 or 6, characterized in that the network element causes a temporal separation of at least t_{gb} between an end of a first data packet and a start of the second transferred data packet.

8. Method according to claim 1, characterized in that the guard band is selected as t_{gb}≧100/B.

9. Method according to claim 1, characterized in that the lower limit frequency of the receiver input is between 0.0005*B and 0.005*B, preferably between 0.001*B and 0.003*B.

10. A method for synchronous transmission of data packets in telecommunication networks, where the data payload to be transmitted is embedded in a frame structure according to standard G.709, wherein
(i) in the ODUk overhead is inserted a connection code in coded form which allocates the data packet concerned to a particular network connection,
(ii) and that within a switching point the FEC part of the frame structure of the data packet is modified so that between the end of the previous data packet and the start of the immediately following data packet is a guard band time t_{gb}>20 ns and that an internal control signal to synchronize subsequent receiver units is generated within the switching center on the data packet.

11. Transmitter for transmission of data packets according to claim 1, wherein means are provided for performance of steps (a) and (b).

12. Receiver for transmission of data packets according to claim 1, wherein means are provided for performance of steps (c), (d) and (e).

13. Receiver according to claim 12, characterized in that a coupling capacitor is provided as a high-pass to raise the lower limit frequency of the receiver input.
